(19) United States
(12) Patent Application Publication
(10) Pub. No.: US 2025/0364591 A1
(43) Pub. Date: Nov. 27, 2025

(54) NEW Li-CONDUCTOR PROTOTYPES IN THE Li-AL-P-O CHEMICAL SPACE FOR ALL-SOLID-STATE BATTERIES

(71) Applicant: SAMSUNG ELECTRONICS CO., LTD., Suwon-si (KR)

(72) Inventors: Mahdi AMACHRAA, cambridge, MA (US); Yan Wang, Brookline, MA (US)

(73) Assignee: SAMSUNG ELECTRONICS CO., LTD., Suwon-si (KR)

(21) Appl. No.: 18/894,978

(22) Filed: Sep. 24, 2024

Related U.S. Application Data
(60) Provisional application No. 63/650,678, filed on May 22, 2024.

(51) Int. Cl. H01M 10/0562; C01B 25/45; H01M 10/052

(52) U.S. Cl. CPC H01M 10/0562; C01B 25/45; H01M 10/052; C01P 2006/40; H01M 2300/0071

(57) ABSTRACT

A lithium-containing oxide has one of the following parent compositions: Li_{7-z}Al₄P₉O₃₂ (z ranges from −1 to 1), Li_{1-z}Al₃(P₃O₁₀)₂ (z ranges from −0.5 to 0.5), Li_{3-z}Al₃(PO₄)₄ (z ranges from −1 to 1), Li_{3-z}Al₂(PO₄)₃ (z ranges from −1 to 1), Li_{7-z}Al₃(P₂O₇)₄ (z ranges from −1 to 1), Li_{3-z}Al(PO₄)₂ (z ranges from −1 to 1). A lithium solid-state battery includes an anode, a cathode, and a solid electrolyte, wherein the solid electrolyte includes the aforementioned lithium-containing oxide. Also, a solid-state battery includes an anode, a cathode, and a solid electrolyte, wherein at least one of the anode and the cathode is coated with a coating which includes the aforementioned lithium-containing oxide.

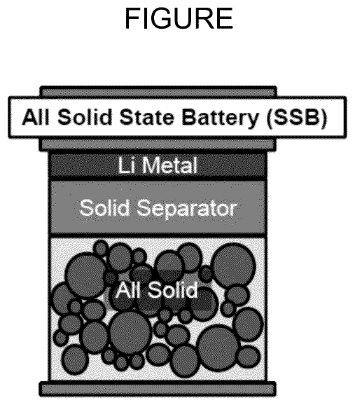

### CROSS-REFERENCE TO RELATED APPLICATION

This application is based on and claims priority from U.S. Provisional Application No. 63/650,678 filed on May 22, 2024 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and/or for use as electrode coatings for solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. An all solid state battery is shown in the FIGURE. In the FIGURE, the all solid component can comprise solid cathode particles in a solid catholyte, and the solid separator can comprise a solid electrolyte.

Solid-state lithium-ion conductors with high ionic conductivities play an important role in SSBs. During the past two decades, there has been an increasing amount of work on new solid-state lithium-ion conductors (SSLICs). And most of them are focused on sulfide SSLICs with high ionic conductivities. However, very limited number of oxide materials were developed for SSBs, and so far only lithium garnet is considered to be the oxide-type electrolyte for lithium SSBs.

For solid-state electrolytes in SSBs, sulfide-based materials have high ionic conductivities (>10 mS/cm) but not really safe (H2S in air condition) and have limited electrochemical stability (for example, unstable against Li metal).

Oxide SSLICs, which own better electrochemical and chemical stability than sulfide SSLICs, have been largely limited in garnet-type materials. The ionic conductivities of reported oxide SSLICs are generally lower than those of sulfide SSLICs.

Solid state electrolyte materials with superionic conductivity and interfacial stability are desirable materials to form all-solid-state Li-metal batteries. However, several problems and challenges are currently being investigated, such as achieving high ionic conductivity at room temperature, ensuring good interfaces between solid-state electrolytes and electrode materials, developing cost-effective solid-state-electrolytes that can compete with currently established liquid electrolyte technologies is also a hurdle for widespread adoption. Currently, very few Li-oxide conductors have been uncovered. Consequently, discovering new compositions within the Li—Al—P—O chemical space is a promising venture to uncover simple, cost-effective, high stability Li-conductors.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—Al—P—O chemical space by applying a machine learning-based crystal structure prediction algorithm.

In this disclosure, novel lithium-containing oxides include the following parent compositions: Li_{7-z}Al₄P₉O₃₂ (z ranges from −1 to 1), Li_{1-z}Al₃(P₃O₁₀)₂ (z ranges from −0.5 to 0.5), Li_{3-z}Al₃(PO₄)₄ (z ranges from −1 to 1), Li_{3-z}Al₂(PO₄)₃ (z ranges from −1 to 1), Li_{7-z}Al₃(P₂O₇)₄ (z ranges from −1 to 1), Li_{3-z}Al₃(PO₄)₂ (z ranges from −1 to 1).

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

A first embodiment of the present disclosure provides a lithium-containing oxide of one of the following parent compositions: Li_{7-z}Al₄P₉O₃₂ (z ranges from −1 to 1), Li_{1-z}Al₃(P₃O₁₀)₂ (z ranges from −0.5 to 0.5), Li_{3-z}Al₃(PO₄)₄ (z ranges from −1 to 1), Li_{3-z}Al₂(PO₄)₃ (z ranges from −1 to 1), Li_{7-z}Al₃(P₂O₇)₄ (z ranges from −1 to 1), Li_{3-z}Al₃(PO₄)₂ (z ranges from −1 to 1).

A second embodiment of the present disclosure provides a lithium-containing oxide of the first embodiment, wherein the lithium-containing oxide is a lithium-containing oxide of the parent composition Li_{7-z}Al₄P₉O₃₂ (z ranges from −1 to 1).

A third embodiment of the present disclosure provides a lithium-containing oxide of the first embodiment, wherein the lithium-containing oxide is a lithium-containing oxide of the parent composition Li_{1-z}Al₃(P₃O₁₀)₂ (z ranges from −0.5 to 0.5).

A fourth embodiment of the present disclosure provides a lithium-containing oxide of the first embodiment, wherein the lithium-containing oxide is a lithium-containing oxide of the parent composition Li_{3-z}Al₃(PO₄)₃ (z ranges from −1 to 1).

A fifth embodiment of the present disclosure provides a lithium-containing oxide of the first embodiment, wherein the lithium-containing oxide is a lithium-containing oxide of the parent composition Li_{3-z}Al₂(PO₄)₃ (z ranges from −1 to 1).

A sixth embodiment of the present disclosure provides a lithium-containing oxide of the first embodiment, wherein the lithium-containing oxide is a lithium-containing oxide of the parent composition Li_{7-z}Al₃(P₂O₇)₄ (z ranges from −1 to 1).

A seventh embodiment of the present disclosure provides a lithium-containing oxide of the first embodiment, wherein the lithium-containing oxide is a lithium-containing oxide of the parent composition Li_{3-z}Al₃(PO₄)₂ (z ranges from −1 to 1).

An eighth embodiment of the present disclosure provides a lithium-containing oxide of the first embodiment, wherein the lithium-containing oxide is Li7Al4P9O32.

A ninth embodiment of the present disclosure provides a lithium-containing oxide of the first embodiment, wherein the lithium-containing oxide is LiAl3(P3O10)2.

A tenth embodiment of the present disclosure provides a lithium-containing oxide of the first embodiment, wherein the lithium-containing oxide is Li3Al3(PO4)4.

An eleventh embodiment of the present disclosure provides a lithium-containing oxide of the first embodiment, wherein the lithium-containing oxide is Li3Al2(PO4)3.

A twelfth embodiment of the present disclosure provides a lithium-containing oxide of the first embodiment, wherein the lithium-containing oxide is Li7Al3(P2O7)4.

A thirteenth embodiment of the present disclosure provides a lithium-containing oxide of the first embodiment, wherein the lithium-containing oxide is Li3Al(PO4)2.

A fourteenth embodiment of the present disclosure provides a lithium solid-state battery comprising an anode, a cathode, and a solid electrolyte, wherein the solid electrolyte comprises a lithium-containing oxide of the first embodiment.

A fifteenth embodiment of the present disclosure provides a lithium solid-state battery of the fourteenth embodiment, wherein the solid electrolyte comprises Li7Al4P9O32, LiAl3(P3O10)2, Li3Al3(PO4)4, Li3Al2(PO4)3, Li7Al3(P2O7)4, or Li3Al(PO4)2.

A sixteenth embodiment of the present disclosure provides a lithium solid-state battery comprising an anode, a cathode, and a solid electrolyte, wherein at least one of the anode and the cathode is coated with a coating which comprises a lithium-containing oxide of the first embodiment.

A seventeenth embodiment of the present disclosure provides a lithium solid-state battery of the sixteenth embodiment, wherein the coating comprises Li7Al4P9O32, LiAl3(P3O10)2, Li3Al3(PO4)4, Li3Al2(PO4)3, Li7Al3(P2O7)4, or Li3Al(PO4)2.

### BRIEF DESCRIPTION OF DRAWINGS

Example embodiments of the present disclosure will be more clearly understood from the following detailed description taken in conjunction with the accompanying drawing in which:

The FIGURE shows an all solid-state battery.

### DETAILED DESCRIPTION OF EXAMPLE EMBODIMENTS

The present disclosure demonstrates several novel compositions within the Li—Al—P—O chemical space with Li-ion conductivity.

In this disclosure, novel lithium-containing oxides include the following parent compositions: Li_{7-z}Al₄P₉O₃₂ (z ranges from −1 to 1), Li_{1-z}Al₃(P₃O₁₀)₂ (z ranges from −0.5 to 0.5), Li_{3-z}Al₃(PO₄)₄ (z ranges from −1 to 1), Li_{3-z}Al₂(PO₄)₃ (z ranges from −1 to 1), Li_{7-z}Al₃(P₂O₇)₄ (z ranges from −1 to 1), Li_{3-z}Al₃(PO₄)₂ (z ranges from −1 to 1). In this regard, it is noted that there can be lithium deficiency associated with oxygen loss in lithium oxide compounds. A general formula for this disclosure can be, e.g., Li_{7-z}Al₄P₉O_{32-w} (z ranges from −1 to 1 and w ranges from −0.5 to 0.5), Li_{1-z}Al₃(P₃O_{10-w})₂ (z ranges from −0.5 to 0.5 and w ranges from −0.125 to 0.125), Li_{3-z}Al₃(PO_{4-w})₄ (z ranges from −1 to 1 and w ranges from −0.125 to 0.125), Li_{3-z}Al₂(PO_{4-w})₃ (z ranges from −1 to 1 and w ranges from −0.167 to 0.167), Li_{7-z}Al₃(P₂O_{7-w})₄ (z ranges from −1 to 1 and w ranges from −0.125 to 0.125), Li_{3-z}Al₃(PO_{4-w})₂ (z ranges from −1 to 1 and w ranges from −0.25 to 0.25). This disclosure also includes the general formula Li_{7-z}Al₄P₉O_{32-w} (z ranges from −1 to 1 and w ranges from 0 to 0.5), Li_{1-z}Al₃(P₃O_{10-w})₂ (z ranges from −0.5 to 0.5 and w ranges from 0 to 0.125), Li_{3-z}Al₃(PO_{4-w})₄ (z ranges from −1 to 1 and w ranges from 0 to 0.125), Li_{3-z}Al₂(PO_{4-w})₃ (z ranges from −1 to 1 and w ranges from 0 to 0.167), Li_{7-z}Al₃(P₂O_{7-w})₄ (z ranges from −1 to 1 and w ranges from 0 to 0.125), Li_{3-z}Al(PO_{4-w})₂ (z ranges from −1 to 1 and w ranges from 0 to 0.25).

In this disclosure, novel Li-ion prototypes within the Li—Al—P—O chemical space include the following formulas: Li7Al4P9O32, LiAl3(P3O10)2, Li3Al3(PO4)4, Li3Al2(PO4)3, Li7Al3(P2O7)4, Li3Al(PO4)2.

Li7Al4P9O32 crystallizes in the tetragonal P-42₁c space group.
Crystal Structure Description: There are three inequivalent Li1+ sites. In the first Li1+ site, Li(1)1+ is bonded in a 4-coordinate geometry to four equivalent O(1)2- atoms. All Li(1)-O(1) bond lengths are 2.50 Å. In the second Li1+ site, Li(2)1+ is bonded in a rectangular see-saw-like geometry to four equivalent O(2)2- atoms. There are two shorter (2.10 Å) and two longer (2.17 Å) Li(2)-O(2) bond lengths. In the third Li1+ site, Li(3)1+ is bonded in a 5-coordinate geometry to one O(2)2-, one O(3)2-, one O(4)2-, one O(5)2-, and one O(6)2-atom. The Li(3)-O(2) bond length is 2.38 Å. The Li(3)-O(3) bond length is 2.29 Å. The Li(3)-O(4) bond length is 2.04 Å. The Li(3)-O(5) bond length is 2.29 Å. The Li(3)-O(6) bond length is 2.27 Å. Al(1)3+ is bonded to one O(1)2-, one O(3)2-, one O(4)2-, one O(6)2-, one O(7)2-, and one O(8)2- atom to form AlO6 octahedra that share a corner-corner with one P(1)O4 tetrahedra, corners with two equivalent P(2)O4 tetrahedra, and corners with three equivalent P(3)O4 tetrahedra. The Al(1)-O(1) bond length is 1.91 Å. The Al(1)-O(3) bond length is 1.96 Å. The Al(1)-O(4) bond length is 1.95 Å. The Al(1)-O(6) bond length is 1.92 Å. The Al(1)-O(7) bond length is 1.88 Å. The Al(1)-O(8) bond length is 1.92 Å. There are three inequivalent P5+ sites. In the first P5+ site, P(3)5+ is bonded to one O(5)2-, one O(6)2-, one O(7)2-, and one O(8)2- atom to form PO4 tetrahedra that share corners with three equivalent Al(1)O6 octahedra and a corner-corner with one P(2)O4 tetrahedra. The corner-sharing octahedral tilt angles range from 34-50°. The P(3)-O(5) bond length is 1.62 Å. The P(3)-O(6) bond length is 1.53 Å. The P(3)-O(7) bond length is 1.52 Å. The P(3)-O(8) bond length is 1.51 Å. In the second P5+ site, P(1)5+ is bonded to four equivalent O(1)2- atoms to form PO4 tetrahedra that share corners with four equivalent Al(1)O6 octahedra. The corner-sharing octahedral tilt angles are 46°. All P(1)-O(1) bond lengths are 1.55 Å. In the third P5+ site, P(2)5+ is bonded to one O(2)2-, one O(3)2-, one O(4)2-, and one O(5)2- atom to form PO4 tetrahedra that share corners with two equivalent Al(1)O6 octahedra and a corner-corner with one P(3)O4 tetrahedra. The corner-sharing octahedral tilt angles range from 46-55°. The P(2)-O(2) bond length is 1.52 Å. The P(2)-O(3) bond length is 1.53 Å. The P(2)-O(4) bond length is 1.53 Å. The P(2)-O(5) bond length is 1.63 Å.
Properties:
   The parent prototype has an energy above hull of 45 meV/atom.
   Li activation energy barrier of 0.33 eV (1-dimensional), 0.48 eV (2-dimensional), 0.48 eV (3-dimensional).
   The reduction potential against Lithium is 2.43 V, while the oxidation potential is 4.29 V, suggesting that this material can be used as anolyte against an alloy anode or graphite anode, or this material can be used as a stable catholyte or a coating material in a solid-state battery that has a different type of anolyte (in batteries, these materials as solid-state electrolyte can form solid-electrolyte interphases by chemical-reaction with electrodes and widen the redox potential window of the electrolytes).
   The reaction energy between the prototype structure and water (H2O) is −0.77 eV/atom suggesting a relatively stable compound in an aqueous environment.

LiAl₃(P₃O₁₀)₂ crystallizes in two distinct space groups: Aea2 and C222₁.
Crystal Structure Description of C222₁: The C222₁ phase is orthorhombic. Li(1)1+ is bonded in a 4-coordinate geometry to two equivalent O(3)2- and two equivalent O(8)2- atoms. Both Li(1)-O(3) bond lengths are 2.87 Å. Both Li(1)-O(8) bond lengths are 2.74 Å. There are three inequivalent Al3+ sites. In the first Al3+ site, Al(1)3+ is bonded to two equivalent O(1)2- and two equivalent O(8)2- atoms to form AlO4 tetrahedra that share corners with two equivalent P(1)O4 tetrahedra and corners with two equivalent P(3)O4 tetrahedra. Both Al(1)-O(1) bond lengths are 1.74 Å. Both Al(1)-O(8) bond lengths are 1.78 Å. In the second Al3+ site, Al(2)3+ is bonded to two equivalent O(2)2-, two equivalent O(5)2-, and two equivalent O(9)2- atoms to form AlO6 octahedra that share corners with two equivalent P(1)O4 tetrahedra, corners with two equivalent P(2)O4 tetrahedra, and corners with two equivalent P(3)O4 tetrahedra. Both Al(2)-O(2) bond lengths are 1.90 Å. Both Al(2)-O(5) bond lengths are 1.93 Å. Both Al(2)-O(9) bond lengths are 1.88 Å. In the third Al3+ site, Al(3)3+ is bonded to two equivalent O(10)2-, two equivalent O(3)2-, and two equivalent O(6)2- atoms to form AlO6 octahedra that share corners with two equivalent P(1)O4 tetrahedra, corners with two equivalent P(2)O4 tetrahedra, and corners with two equivalent P(3)O4 tetrahedra. Both Al(3)-O(10) bond lengths are 1.86 Å. Both Al(3)-O(3) bond lengths are 1.93 Å. Both Al(3)-O(6) bond lengths are 1.89 Å. There are three inequivalent P5+ sites.
Properties:
   The prototype structure has an energy above hull of 47 meV/atom, and Li activation energy barrier of 0.4 eV (1-dimensional), 0.45 eV (2-dimensional), 0.45 eV (3-dimensional).
   The reduction potential against Lithium is 2.62 V, while the oxidation potential is 4.45 V, suggesting that this material can be used as anolyte against an alloy anode or graphite anode.
   The reaction energy between the prototype structure and water is −0.81 eV/atom suggesting a relatively stable compound against water.
Crystal Structure Description of Aea2: The Aea2 phase is also orthorhombic. Li(1)1+ is bonded in a 2-coordinate geometry to two equivalent O(8)2- atoms. Both Li(1)-O(8) bond lengths are 2.55 Å. There are two inequivalent Al3+ sites. In the first Al3+ site, Al(1)3+ is bonded to two equivalent O(1)2- and two equivalent O(8)2- atoms to form AlO4 tetrahedra that share corners with two equivalent P(1)O4 tetrahedra and corners with two equivalent P(3)O4 tetrahedra. Both Al(1)-O(1) bond lengths are 1.74 Å. Both Al(1)-O(8) bond lengths are 1.79 Å. In the second Al3+ site, Al(2)3+ is bonded to one O(10)2-, one O(2)2-, one O(3)2-, one O(5)2-, one O(6)2-, and one O(9)2- atom to form AlO6 octahedra that share corners with two equivalent P(1)O4 tetrahedra, corners with two equivalent P(2)O4 tetrahedra, and corners with two equivalent P(3)O4 tetrahedra. The Al(2)-O(10) bond length is 1.89 Å. The Al(2)-O(2) bond length is 1.86 Å. The Al(2)-O(3) bond length is 1.90 Å. The Al(2)-O(5) bond length is 1.89 Å. The Al(2)-O(6) bond length is 1.94 Å. The Al(2)-O(9) bond length is 1.87 Å. There are three inequivalent P5+ sites. In the first P5+ site, P(1)5+ is bonded to one O(1)2-, one O(2)2-, one O(3)2-, and one O(4)2-atom to form PO4 tetrahedra that share corners with two equivalent Al(2)O6 octahedra, a corner-corner with one Al(1)O4 tetrahedra, and a corner-corner with one P(2)O4 tetrahedra. The corner-sharing octahedral tilt angles range from 26-47°. The P(1)-O(1) bond length is 1.54 Å. The P(1)-O(2) bond length is 1.49 Å. The P(1)-O(3) bond length is 1.52 Å. The P(1)-O(4) bond length is 1.64 Å. In the second P5+ site, P(2)5+ is bonded to one O(4)2-, one O(5)2-, one O(6)2-, and one O(7)2- atom to form PO4 tetrahedra that share corners with two equivalent Al(2)O6 octahedra, a corner-corner with one P(1)O4 tetrahedra, and a corner-corner with one P(3)O4 tetrahedra. The corner-sharing octahedral tilt angles range from 12-52°. The P(2)-O(4) bond length is 1.61 Å. The P(2)-O(5) bond length is 1.49 Å. The P(2)-O(6) bond length is 1.50 Å. The P(2)-O(7) bond length is 1.60 Å. In the third P5+ site, P(3)5+ is bonded to one O(10)2-, one O(7)2-, one O(8)2-, and one O(9)2- atom to form PO4 tetrahedra that share corners with two equivalent Al(2)O6 octahedra, a corner-corner with one Al(1)O4 tetrahedra, and a corner-corner with one P(2)O4 tetrahedra. The corner-sharing octahedral tilt angles range from 16-37°. The P(3)-O(10) bond length is 1.51 Å. The P(3)-O(7) bond length is 1.63 Å. The P(3)-O(8) bond length is 1.57 Å. The P(3)-O(9) bond length is 1.49 Å.
Properties:
   The prototype structure has an energy above hull of 55 meV/atom.
   Li activation energy barrier of 0.25 eV (1-dimensional), 0.25 eV (2-dimensional), 0.33 eV (3-dimensional). The reduction potential against Lithium is 2.62 V, while the oxidation potential is 4.45 V, suggesting that this material can be used as anolyte against an alloy anode or graphite anode, or a catholyte or a coating material in a solid-state battery that has another anolyte.
   The reaction energy between the prototype structure and water is −0.94 eV/atom suggesting a relatively stable compound against in aqueous environment.

Li3Al3(PO₄)₄ crystallizes in the monoclinic C2/c space group.
Crystal Structure Description: There are two inequivalent Li1+ sites. In the first Li1+ site, Li(1)1+ is bonded in a 6-coordinate geometry to two equivalent O(5)2-, two equivalent O(6)2-, and two equivalent O(7)2- atoms. Both Li(1)-0(5) bond lengths are 2.19 Å. Both Li(1)-O(6) bond lengths are 2.29 Å. Both Li(1)-O(7) bond lengths are 2.48 Å. In the second Li1+ site, Li(2)1+ is bonded in a 5-coordinate geometry to one O(1)2-, one O(6)2-, one O(8)2-, and two equivalent O(7)2- atoms. The Li(2)-O(1) bond length is 2.45 Å. The Li(2)-O(6) bond length is 2.31 Å. The Li(2)-O(8) bond length is 2.55 Å. There is one shorter (1.97 Å) and one longer (2.32 Å) Li(2)-O(7) bond length. There are two inequivalent Al3+ sites. In the first Al3+ site, Al(1)3+ is bonded to two equivalent O(2)2-, two equivalent O(4)2-, and two equivalent O(8)2- atoms to form AlO6 octahedra that share corners with four equivalent Al(2)O6 octahedra, corners with two equivalent P(2)O4 tetrahedra, and corners with four equivalent P(1)O4 tetrahedra. The corner-sharing octahedral tilt angles range from 54-56°. Both Al(1)-O(2) bond lengths are 1.90 Å. Both Al(1)-O(4) bond lengths are 1.96 Å. Both Al(1)-O(8) bond lengths are 1.86 Å. In the second Al3+ site, Al(2)3+ is bonded to one O(1)2-, one O(2)2-, one O(3)2-, one O(4)2-, one O(5)2-, and one O(6)2- atom to form AlO6 octahedra that share corners with two equivalent Al(1)O6 octahedra, corners with two equivalent P(1)O4 tetrahedra, corners with two equivalent P(2)O4 tetrahedra, and an edge-edge with one P(1)O4 tetrahedra. The corner-sharing octahedral tilt angles range from 54-56°. The Al(2)-O(1) bond length is 1.91 Å. The Al(2)-O(2) bond length is 1.96 Å. The Al(2)-O(3) bond length is 1.92 Å. The Al(2)-O(4) bond length is 2.05 Å. The Al(2)-O(5) bond length is 1.86 Å. The Al(2)-O(6) bond length is 1.84 Å. There are two inequivalent P5+ sites.
Properties:
   The prototype structure has an energy above hull of 52 meV/atom.
   Li activation energy barrier of 0.33 eV (1-dimensional), 0.36 eV (2-dimensional), 0.36 eV (3-dimensional).
   The reduction potential against Lithium is 1.96 V, while the oxidation potential is 4.2 V, suggesting that this material can be used as anolyte against an alloy anode or graphite anode, or a catholyte or a coating material in a solid-state battery that has another anolyte.
   The reaction energy between the prototype structure and water is 0 eV/atom suggesting a stable compound against water.

Li3Al2(PO4)3 crystallizes in 7 different space groups, namely, R-3, P2₁/c, Cc. C2/c, I4₁32, Ia-3d, I4₁/a.
Properties:
   The reduction potential for all of these phases is 1.94 V and the oxidation potential is 4.2 V suggesting that this material can be used as anolyte against an alloy anode or graphite anode, or a catholyte or a coating material in a solid-state battery that has another anolyte.
   The reaction energy between the prototype structure and water is 0 eV/atom suggesting a stable compound against water.
   The R-3 phase has an energy above hull of 26.95 meV/atom and Li activation of 0.61 eV (1-dimensional), 0.61 eV (2-dimensional), 0.64 eV (3-dimensional).
   The P2₁/c phase has energy above hull of 29.0 meV/atom, and Li activation of 0.40 eV (1-dimensional), 0.41 eV (2-dimensional), 0.42 eV (3-dimensional).
   The C2/c phase has an energy above hull of 45 meV/atom, and Li activation energy of 0.64 eV (1-dimensional), 0.65 eV (2-dimensional), 0.80 eV (3-dimensional).
   The I4₁/a phase has an energy above hull of 52 meV/atom, and Li activation energy of 0.38 eV (1-dimensional), 0.38 eV (2-dimensional), 0.38 eV (3-dimensional).

Li7Al3(P2O7)4 crystallizes in two different space groups: C2/c and P21/c.
Properties:
   The reduction potential for all of these phases is 2.43 V and the oxidation potential is 4.29 V, suggesting that this material can be used as anolyte against an alloy anode or graphite anode, or a catholyte or a coating material in a solid-state battery that has another anolyte.
   The reaction energy between the prototype structure and water is −0.77 eV/atom suggesting a stable compound against water.
   The C2/c phase has an energy above hull of 53 meV/atom and Li activation energy of 0.57 eV (1-dimensional), 0.57 eV (2-dimensional), 0.79 eV (3-dimensional).
   The P2₁/c phase has an energy above hull of 56 meV/atom and Li activation energy of 0.53 eV (1-dimensional), 0.48 eV (2-dimensional), 0.57 eV (3-dimensional).

Li3Al(PO4)2 crystallizes in the P-1 and C2/m phase.
Properties:
   The energy above hull ranges from 52 meV/atom to 55 meV/atom and Li activation of 0.62 eV (1-dimensional), 0.66 eV (2-dimensional), 0.72 eV (3-dimensional).
   The reduction potential for all of these phases is 1.94 V and the oxidation potential is 4.20 V, suggesting that this material can be used as anolyte against an alloy anode or graphite anode, or a catholyte or a coating material in a solid-state battery that has another anolyte.
   The reaction energy between the prototype structure and water is 0 eV/atom suggesting a stable compound against water.

High-throughput data-mining was conducted to derive novel prototype Li-containing structures, and advanced data analytics was performed to extract novel Li-ion conductors that are stable against Li metal, stable anolyte against various types of anodes such as alloy anode or graphite anode, stable catholytes and stable coating materials in all-solid state batteries.

The lithium-containing oxides in this disclosure can be made by a standard solid-state method. In this method, precursor powders are combined in a certain ratio depending on the composition of the target material. As one example, precursors may consist of lithium carbonate (Li₂CO₃), aluminum oxide (Al₂O₃), and phosphoric acid (H₃PO₄), and as another example, precursors may consist of lithium oxide (Li₂O), aluminum oxide, and phosphoric acid.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature (e.g., 500-1000° C.) for an appropriate period of time (e.g., 6-12 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., 6-12 hours) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

### EXAMPLES

Embodiments will now be illustrated by way of the following examples, which do not limit the embodiments in any way.

A machine learning-based crystal structure prediction algorithm was applied to obtain the following compositions as set forth in Table 1.

TABLE 1

| | | | | | | | | | H2O | | | |
|---|---|---|---|---|---|---|---|---|---|---|---|---|
| Host | | Chemical | Mobile | | | | | | R × N | H2O | | |
| ID | Formula | Space | Ion | E_1D | E_2D | E_3D | Vred | Vox | Energy | Content | Ehull | SPG |
| 83567 | Li3Al(PO4)2 | Al—Li—O—P | Li1+ | 0.62 | 0.66 | 0.72 | 1.94 | 4.2 | 0.0 | 1.0 | 55.07 | P-1 |
| 83415 | Li3Al2(PO4)3 | Al—Li—O—P | Li1+ | 0.47 | 0.48 | 0.49 | 1.94 | 4.2 | 0.0 | −0.0 | 31.6 | P2₁/c |
| 83769 | Li3Al2(PO4)3 | Al—Li—O—P | Li1+ | 0.42 | 0.52 | 0.54 | 1.94 | 4.2 | 0.0 | −0.0 | 28.99 | P2₁/c |
| 83080 | Li3Al2(PO4)3 | Al—Li—O—P | Li1+ | 0.64 | 0.65 | 0.8 | 1.94 | 4.2 | 0.0 | −0.0 | 45.77 | C2/c |
| 83083 | Li3A12(PO4)3 | Al—Li—O—P | Li1+ | 0.38 | 0.38 | 0.38 | 1.94 | 4.2 | 0.0 | −0.0 | 52.38 | I4₁/a |
| 83207 | Li3Al2(PO4)3 | Al—Li—O—P | Li1+ | 0.61 | 0.61 | 0.64 | 1.94 | 4.2 | 0.0 | −0.0 | 26.95 | R-3 |
| 83318 | Li3Al2(PO4)3 | Al—Li—O—P | Li1+ | 0.4 | 0.41 | 0.43 | 1.94 | 4.2 | 0.0 | −0.0 | 32.93 | P2₁/c |
| 83075 | Li3Al3(PO4)4 | Al—Li—O—P | Li1+ | 0.33 | 0.36 | 0.36 | 1.94 | 4.2 | 0.0 | 1.0 | 52.76 | C2/c |
| 83151 | Li7Al3(P2O7)4 | Al—Li—O—P | Li1+ | 0.57 | 0.57 | 0.79 | 2.43 | 4.29 | −0.77 | 0.75 | 53.37 | C2/c |
| 83339 | Li7Al3(P2O7)4 | Al—Li—O—P | Li1+ | 0.43 | 0.48 | 0.57 | 2.43 | 4.29 | −0.8 | 0.75 | 56.5 | P2₁/c |
| 83387 | Li7Al4P9O32 | Al—Li—O—P | Li1+ | 0.33 | 0.48 | 0.48 | 2.43 | 4.29 | −0.77 | 0.75 | 47.44 | P-42₁c |
| 83333 | Li7Al4P9O32 | Al—Li—O—P | Li1+ | 0.23 | 0.23 | 0.26 | 2.43 | 4.29 | −0.81 | 0.75 | 50.48 | P-42₁c |
| 83665 | LiAl3(P3O10)2 | Al—Li—O—P | Li1+ | 0.4 | 0.45 | 0.45 | 2.62 | 4.45 | −0.81 | 0.5 | 47.28 | C222₁ |
| 83177 | LiAl3(P3O10)2 | Al—Li—O—P | Li1+ | 0.26 | 0.26 | 0.33 | 2.62 | 4.45 | −0.94 | 0.5 | 55.79 | Aea2 |

As can be seen from the results presented in Table 1, the 2.43 V reduction potential against Li and the 4.29 V oxidation potential for the Li7Al4P9O32 composition suggest that the composition can be used as anolyte against an alloy anode or graphite anode, or as a stable catholyte or a coating material in a solid-state battery that has a different type of anolyte (again, in batteries, these materials as solid-state electrolyte can form solid-electrolyte interphases by chemical reaction with electrodes and widen the redox potential window of the electrolytes; this applies to the materials below as well), and the reaction energy between the prototype structure and H2O is −0.77 eV/atom, suggesting a relatively stable compound in an aqueous environment. Also, the 2.62 V reduction potential against Li and the 4.45 V oxidation potential for both space groups of the LiAl3(P3O10)2 composition suggest that this material can be used as anolyte against an alloy anode or graphite anode, and the reaction energy between the C2221 phase of the LiAl3(P3O10)2 composition and H2O is −0.81 eV/atom and between the Aea2 phase of the LiAl3(P3O10)2 composition and H2O is −0.94 eV/atom, suggesting a relatively stable compound against water. In addition, the 1.94 V reduction potential against Li and the 4.2 V oxidation potential for the Li3Al3(PO4)4 composition suggest that the composition can be used as anolyte against an alloy anode or graphite anode, or a catholyte or a coating material in a solid-state battery that has another anolyte, and the reaction energy between the prototype structure and H2O is 0 eV/atom, suggesting a stable compound against water. Further, the 1.94 V reduction potential against Li and the 4.2 V oxidation potential for all phases of the Li3Al2(PO4)3 composition suggest that the composition can be used as anolyte against an alloy anode or graphite anode, or a catholyte or a coating material in a solid-state battery that has another anolyte, and the reaction energy between these phases and H2O is −0.77 eV/atom, suggesting a stable compound against water. Moreover, the 2.43 V reduction potential against Li and the 4.29 V oxidation potential for both space groups of the Li7Al3(P2O7)4 composition suggest that this material can be used as anolyte against an alloy anode or graphite anode, or a catholyte or a coating material in a solid-state battery that has another anolyte, and the reaction energy between the C2/c phase of the Li7Al3(P2O7)4 composition and H2O is −0.77 eV/atom and between the P21/c phase of the Li7Al3(P2O7)4 composition and H2O is −0.8 eV/atom, suggesting a relatively stable compound against water. Additionally, the 1.94 V reduction potential against Li and the 4.20 V oxidation potential for the Li3Al(PO4)2 composition suggest that the composition can be used as anolyte against an alloy anode or graphite anode, or a catholyte or a coating material in a solid-state battery that has another anolyte, and the reaction energy between the Li3Al(PO4)2 composition and H2O is 0 eV/atom, suggesting a stable compound against water.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium-containing oxide of one of the following parent compositions:
Li_{7-z}Al₄P₉O₃₂, where z ranges from −1 to 1,
Li_{1-z}Al₃(P₃O₁₀)₂, where z ranges from −0.5 to 0.5,
Li_{3-z}Al₃(PO₄)₄, where z ranges from −1 to 1,
Li_{3-z}Al₂(PO₄)₃, where z ranges from −1 to 1,
Li_{7-z}Al₃(P₂O₇)₄, where z ranges from −1 to 1, or
Li_{3-z}Al₃(PO₄)₂, where z ranges from −1 to 1.

2. The lithium-containing oxide of claim 1, wherein the lithium-containing oxide is a lithium-containing oxide of the parent composition Li_{7-z}Al₄P₉O₃₂, where z ranges from −1 to 1.

3. The lithium-containing oxide of claim 1, wherein the lithium-containing oxide is a lithium-containing oxide of the parent composition Li_{1-z}Al₃(P₃O₁₀)₂, where z ranges from −0.5 to 0.5.

4. The lithium-containing oxide of claim 1, wherein the lithium-containing oxide is a lithium-containing oxide of the parent composition Li_{3-z}Al₃(PO₄)₄, where z ranges from −1 to 1.

5. The lithium-containing oxide of claim 1, wherein the lithium-containing oxide is a lithium-containing oxide of the parent composition Li_{3-z}Al₂(PO₄)₃, where z ranges from −1 to 1.

6. The lithium-containing oxide of claim 1, wherein the lithium-containing oxide is a lithium-containing oxide of the parent composition Li_{7-z}Al₃(P₂O₇)₄, where z ranges from −1 to 1.

7. The lithium-containing oxide of claim 1, wherein the lithium-containing oxide is a lithium-containing oxide of the parent composition Li_{3-z}Al₃(PO₄)₂, where z ranges from −1 to 1.

8. The lithium-containing oxide of claim 1, wherein the lithium-containing oxide is Li7Al4P9O32.

9. The lithium-containing oxide of claim 1, wherein the lithium-containing oxide is LiAl3(P3O10)2.

10. The lithium-containing oxide of claim 1, wherein the lithium-containing oxide is Li3Al3(PO4)4.

11. The lithium-containing oxide of claim 1, wherein the lithium-containing oxide is Li3Al2(PO4)3.

12. The lithium-containing oxide of claim 1, wherein the lithium-containing oxide is Li7Al3(P2O7)₄.

13. The lithium-containing oxide of claim 1, wherein the lithium-containing oxide is Li3Al(PO4)2.

14. A lithium solid-state battery comprising an anode, a cathode, and a solid electrolyte, wherein the solid electrolyte comprises a lithium-containing oxide of claim 1.

15. The lithium solid-state battery of claim 14, wherein the solid electrolyte comprises Li7Al4P9O32, LiAl3(P3O10)2, Li3Al3(PO4)4, Li3Al2(PO4)3, Li7Al3(P2O7)4, or Li3Al(PO4)2.

16. A lithium solid-state battery comprising an anode, a cathode, and a solid electrolyte, wherein at least one of the anode and the cathode is coated with a coating which comprises a lithium-containing oxide of claim 1.

17. The lithium solid-state battery of claim 16, wherein the coating comprises Li7Al4P9O32, LiAl3(P3O10)2, Li3Al3(PO4)4, Li3Al2(PO4)3, Li7Al3(P2O7)4, or Li3Al(PO4)2.
